(19) United States
(12) Patent Application Publication
(10) Pub. No.: US 2014/0239090 A1
(43) Pub. Date: Aug. 28, 2014

(54) INJECTOR, FUEL INJECTION SYSTEM, AND CONSTRUCTION MACHINE PROVIDED WITH SAME

(71) Applicant: Hitachi Construction Machinery Co., Ltd., Tsuchiura, Ibaraki (JP)

(72) Inventors: Wataru Minami, Tsuchiura (JP); Shouji Yamaguchi, Tsuchirura (JP); Yasushi Arai, Tsuchiura (JP); Kouji Tahara, Tsuchiura (JP)

(21) Appl. No.: 14/233,944

(22) PCT Filed: Jul. 22, 2011
(86) PCT No.: PCT/JP2011/066759

§ 371 Date: May 1, 2014

(51) Int. Cl. F02M 61/16

(52) U.S. Cl. CPC F02M 61/16
USPC 239/113; 239/112

(57) ABSTRACT

In the present invention, a cylinder chamber is provided in a main injector body having a nozzle that injects fuel. In the cylinder chamber, a command piston for driving a needle that opens and closes the nozzle is reciprocably received. A cleaning liquid supply pathway for supplying cleaning liquid and a cleaning liquid discharge pathway for discharging cleaning liquid are connected to the cylinder chamber. As a result, adhesive accretions in the cylinder chamber of the main injector body are discharged out of the cylinder chamber together with the cleaning liquid, and therefore it is possible to prevent a negative effect resulting from the adhesive accretions without using an additive or the like.

### TECHNICAL FIELD

The present invention relates to an injector (fuel injection device) and a fuel injection system for a diesel engine provided on, for example, a construction machine, bus and truck. The present invention also relates to a construction machine equipped with such injector and fuel injection system.

### BACKGROUND ART

In recent years, diesel engines having a new type of fuel injection system such as a common rail-type high pressure fuel injection system are increasing. This system is a system that distributes a fuel, pressurized by a fuel pump to a ultrahigh pressure (about 150-200 MPa), to injectors (fuel injection devices) of respective cylinders from a single pipe (referred to as a common rail) to inject the fuel from the injectors. By using an electronic control technology to fine control the fuel injection timing and the injection amount per one thousandth second, it is possible to optimize the amount of fuel injection, increase an output performance, reduce air pollutant such as PM (particulate matters included in, for example, a black smoke) and NOx due to incomplete combustion, and reduce fuel consumption.

Injectors used in such common rail-type fuel injection system are expected to achieve higher pressure and higher-quality response than the existing systems, i.e., expected to demonstrate higher performances. For example, the injector disclosed in Patent Document 1 (see the list of the prior art references below) includes a needle 16 that receives an axial force in a valve-opening direction, and a command piston 17 that receives an axial force in a valve-closing direction. An axial end of the needle 16 is caused to abut an axial end of the command piston 17, and that end of the command piston 17 is slidably supported by a lower body 11. Such structure can prevent the axial misalignment of the needle-contact-end X of the command piston 17 even if the lower body 11 bends. Accordingly, the axial force is only applied onto the contact portion between the needle 16 and the command piston 17 in the axial direction. Thus, no lateral load is applied on the needle sliding part B, and the sliding movement of the needle 16 is not deteriorated.

In addition, higher machining preciseness (accuracy) is demanded as the injector performances are enhanced. The sliding parts in the injector often have a clearance less than 0.1 mm. These parts may cause the malfunction or operation deficiencies when adhesive accretions or sticky matters, which are generated due to deterioration of the oil, attach to the parts. In order to address this problem, Patent Document 2 teaches a method for preventing the malfunction of the injector by removing the attached sticky matters or by including an additive in the fuel beforehand for the purpose of restricting the generation of the sticky matters.

### LIST OF PRIOR ART REFERENCES

### Patent Documents

PATENT DOCUMENT 1: Japanese Patent No. 4552890

PATENT DOCUMENT 2: Japanese Patent Application Publication No. 2009-185306

### SUMMARY OF THE INVENTION

### Problems to be Solved by the Invention

When the additive is included in the fuel to remove the attached sticky matters or restrict the generation of the sticky matters, as disclosed in Patent Document 2, a combination of the additive and another additive may cause inconveniences or disadvantages. In particular, relocatable machines that are often used at different sites may receive a fuel from different sources, and therefore the relocatable machines have a high probability of suffering from the inconveniences. Also, those fuels which do not contain any effective additive exist in the market. Thus, it is impossible to promise the reliability (proper functioning) of the machine. Further, the additive used in the fuel can hardly include a metal composition that would generate ash, and therefore the main composition would be organic. This may cause the additive itself to degenerate due to heat and/or oxidation, and bring about problems.

The present invention was developed to address these problems, and its object is to provide a novel injector (fuel injection device) and a novel fuel injection system for a diesel engine that can reduce or eliminate generation of sticky matters without using additives or other additional agents, and to provide a construction machine equipped with such injector and fuel injection system.

### Solution to Solve the Problems

The light oil (or gas oil) used as a fuel for a diesel engine contains a component (composition) that may generate a sludge, and the heat from the engine and oxidation reaction create the sludge from this component of the fuel. In general, if the fuel is heated and reacts with oxygen, the fuel is deteriorated and the sludge is generated. This is a known fact, and described in the section of “method for generating a sludge in a fuel” of ASTM D2275 (American Society for Testing and Materials). In this experimental method, the fuel in a glass tube is heated and oxidized. If you observe the fuel before and after the experiment, you will see that the sludge does not exist on the glass wall but exists evenly in the liquid, and that the sludge precipitates at the bottom of the glass tube if the glass tube is left as it is after the experiment. Out of the sludge that has precipitated in the fuel, that part of the sludge which has adhesiveness attaches onto components of the injector in the form of “attached sticky matters (or adhesive accretion)” and these sticky matters adversely affect the operation and performances of the injector.

The common rail-type high pressure fuel injection system is expected to operate with a very short response time in order to inject the fuel into the cylinders. Because a plurality of fuel injection is required for one cycle movement of the piston of the engine, a plurality of fuel injector operations is required. The injector components use the fuel (light oil) to ensure the slidability between the injector components. The staying time of the fuel in the fuel pathways can be long and short, depending upon the fuel pathways extending between the components. If the fuel stays in the pathway for a long time, the fuel tends to receive more heat from the engine and is likely to degrade.

Some components among the injector components may collide with each other. Upon such collision, a certain composition of the fuel demonstrates the oiling effect and/or the extreme pressure moderating effect, and that composition is deteriorated. The sticky matters educe in the deteriorated fuel. These sticky matters usually float in the fuel but precipitate due to the gravity when the injector stops the operation and the fuel stops flowing. After the precipitation, the sticky matters are accumulated inside the injector and hinder the movements of the components. This obstructs the appropriate operation of the components. On the other hand, if an additive is added into the fuel, as described earlier, the already-explained inconveniences would occur.

In order to address the problems, a first aspect of the present invention provides an injector that includes a cylinder chamber provided in an injector main body, the injector main body having a nozzle for injecting a fuel, and a command piston slidably received in the cylinder chamber for driving a needle, the needle being configured to open and close the nozzle, wherein a cleaning liquid supply pathway for supplying a cleaning liquid to the cylinder chamber is connected to the cylinder chamber, and a cleaning liquid discharge pathway for discharging the cleaning liquid from the cylinder chamber is connected to the cylinder chamber.

This configuration makes it possible to effectively clean the interior of the cylinder chamber of the injector main body with the cleaning liquid supplied from the cleaning liquid supply pathway. As a result, it is possible to restrict the generation of adhesive accretions or sticky matters (sludge) without using an additive or the like that would adversely affect the fuel composition as described above. Even if the sticky matters are generated, the sticky matters are discharged out of the cylinder chamber together with the cleaning liquid. As such, it is possible to reliably prevent inconveniences such as adhesion of the sticky matters onto the cylinder chamber wall and the command piston, which would otherwise cause hindered movements of the command piston and other troubles.

A second aspect of the present invention provides another injector, wherein the cylinder chamber of the injector of the first aspect has a cylindrical shape, with its cross sectional shape being circular, and one or both of the cleaning liquid supply pathway and the cleaning liquid discharge pathway are connected to the cylinder chamber in a tangential direction.

With this configuration, the cleaning liquid flows in a spiral way along the wall of the cylinder chamber. Therefore, it is possible to supply and discharge the cleaning liquid smoothly. This realizes an improved cleaning effect.

A third aspect of the present invention provides another injector, wherein the cleaning liquid supply pathway of the injector according to the first or second aspect of the invention is connected to one end of the cylinder chamber, and the cleaning liquid discharge pathway is connected to another end of the cylinder chamber. With this configuration, the cleaning liquid can reach every part of the interior of the cylinder chamber, and therefore stagnation and deterioration of part of the fuel in the cylinder chamber is prevented. Accordingly, an improved cleaning effect can be expected.

A fourth aspect of the present invention provides another injector, wherein the fuel is used as the cleaning liquid in any one of the first to third aspects of the invention. With this configuration, even if the cleaning liquid introduced to the cylinder chamber mixes with the fuel to be injected from the nozzle, it does not adversely affect the movement and operation of the injector. In addition, there is no need to prepare a separate cleaning liquid. This contributes to cost reduction and eliminates the need for maintenance such as monitoring (inspection) and supplementation of the cleaning liquid.

A fifth aspect of the present invention provides another injector, wherein the injector according to any one of the first to fourth aspects of the invention further includes a fuel supply pathway for feeding the fuel to the injector main body and a fuel discharge pathway for discharging the fuel from the injector main body, and the cleaning liquid discharge pathway joins the fuel discharge pathway. With such configuration, there is no need to make a separate fuel discharge pathway because the fuel discharge pathway can be used as the cleaning liquid discharge pathway.

A sixth aspect of the present invention provides another injector, wherein the injector according to any one of the first to fourth aspects of the invention further includes a fuel supply pathway for feeding the fuel to the injector main body and a fuel discharge pathway for discharging the fuel from the injector main body, and the fuel discharge pathway joins the cleaning liquid supply pathway. Such configuration can reduce or eliminate a cost related to preparation of a dedicated cleaning liquid for cleaning use because the fuel discharged from the fuel discharge pathway can be used as the cleaning liquid to be supplied to the cylinder chamber from the cleaning liquid supply pathway. In addition, this eliminates the maintenance such as monitoring and filling up of the cleaning liquid.

A seventh aspect of the present invention provides another injector, wherein the injector according to any one of the first to fourth aspects of the invention further includes a fuel supply pathway for feeding the fuel to the injector main body and a fuel discharge pathway for discharging the fuel from the injector main body, and the fuel discharge pathway is connected to the cylinder chamber such that the fuel discharge pathway is used as the cleaning liquid supply pathway. The configuration can demonstrate similar functions and advantages to the injector of the sixth aspect of the invention, and can further simplify the structure.

An eighth aspect of the present invention provides a fuel injection system configured to inject a fuel upon supplying the fuel to the injector defined in any one of the first to seventh aspects of the invention. This fuel injection system includes an injector cleaning means for supplying the cleaning liquid to the cleaning liquid supply pathway to clean the cylinder chamber when an engine equipped with the injector is deactivated.

As mentioned earlier, the sticky matters generated in the cylinder chamber slowly precipitate due to gravity upon deactivation of the engine and stoppage of the fuel flow in the cylinder chamber. As a result, the sticky matters accumulate and adhere on the bottom of the cylinder chamber, and often obstacle the movements of the command piston and other components. Provision of the injector cleaning means can prevent the sticky matters from precipitating and adhering on the cylinder chamber bottom. Also, no cleaning is carried out when the engine is operating, and therefore unexpected phenomena would not occur.

A ninth aspect of the present invention provides a construction machine equipped with the fuel injection system of the eighth aspect of the invention. Provision of the fuel injection system contributes to stable operation of the engine for a long period, and can provide a highly reliable construction machine.

### Advantages of the Invention

According to the present invention, the cleaning liquid supplied from the cleaning liquid supply pathway can effectively clean the inside of the cylinder chamber of the injector main body. Therefore, it is possible to reduce or eliminate the generation of sticky matters (sludge) in the cylinder chamber without use of an additive that would adversely affect the fuel composition as mentioned above. Even if the sticky matters are generated, the invention can also discharge the sticky matters from the cylinder chamber together with the cleaning liquid. Accordingly, it is possible to securely prevent inconveniences such as hindered movements of the command piston which would otherwise be caused by adhesion of the sticky matters on the wall of the cylinder chamber and the command piston.

### BRIEF DESCRIPTION OF THE DRAWINGS

FIG. 1 is a vertical cross-sectional view of an exemplary embodiment (during fuel injection) of an injector 100 according to the present invention.

FIG. 2 is a vertical cross-sectional view of the exemplary embodiment (during no fuel injection) of the injector 100 according to the present invention.

FIG. 3 is a cross-sectional view taken along the line A-A in FIG. 2.

FIG. 4 illustrates a general view of an exemplary embodiment of a fuel injection system 200 according to the present invention.

FIG. 5 is a flowchart of one example of cleaning control applied to the injector 100.

FIG. 6 is a vertical cross-sectional view of another exemplary embodiment of the injector 100 according to the present invention.

FIG. 7 is a vertical cross-sectional view of still another exemplary embodiment of the injector 100 according to the present invention.

FIG. 8 is a vertical cross-sectional view of yet another exemplary embodiment of the injector 100 according to the present invention.

### MODE FOR CARRYING OUT THE INVENTION

Embodiments according to the present invention are now described with reference to the accompanying drawings.

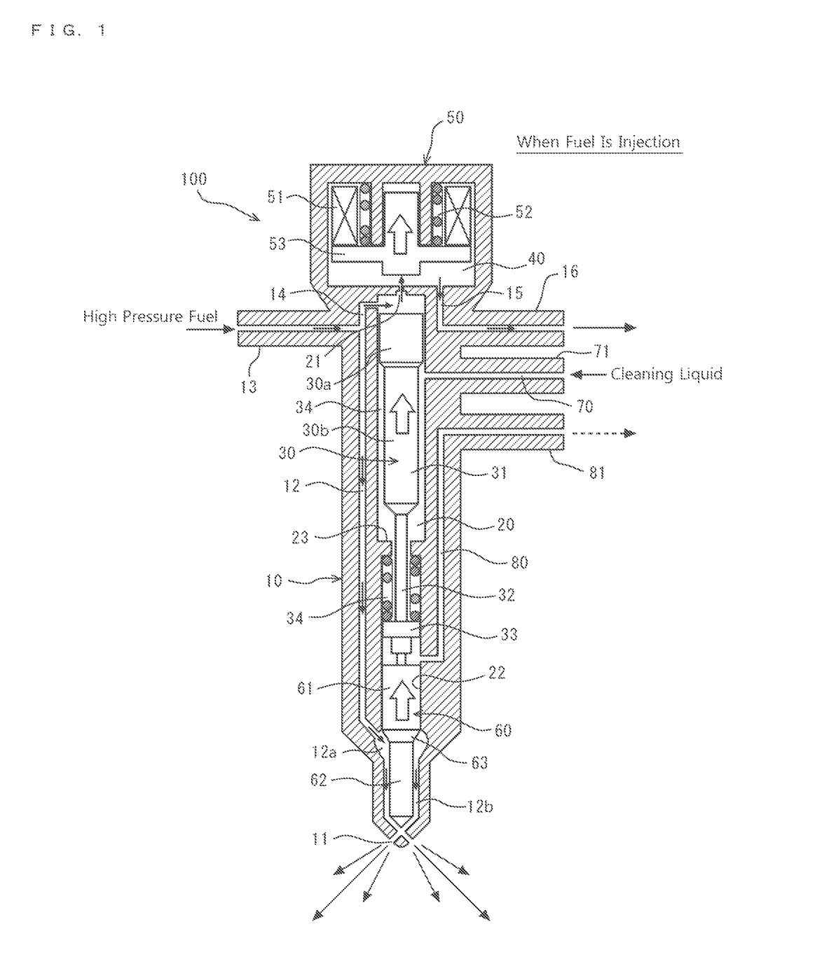

FIG. 1 shows one embodiment of the injector 100 according to the present invention. As illustrated, the injector 100 includes a cylinder chamber 20 in an injector main body 10, which has a vertically extending cylindrical shape, and slidably receives a command piston 30 in the cylinder chamber 20.

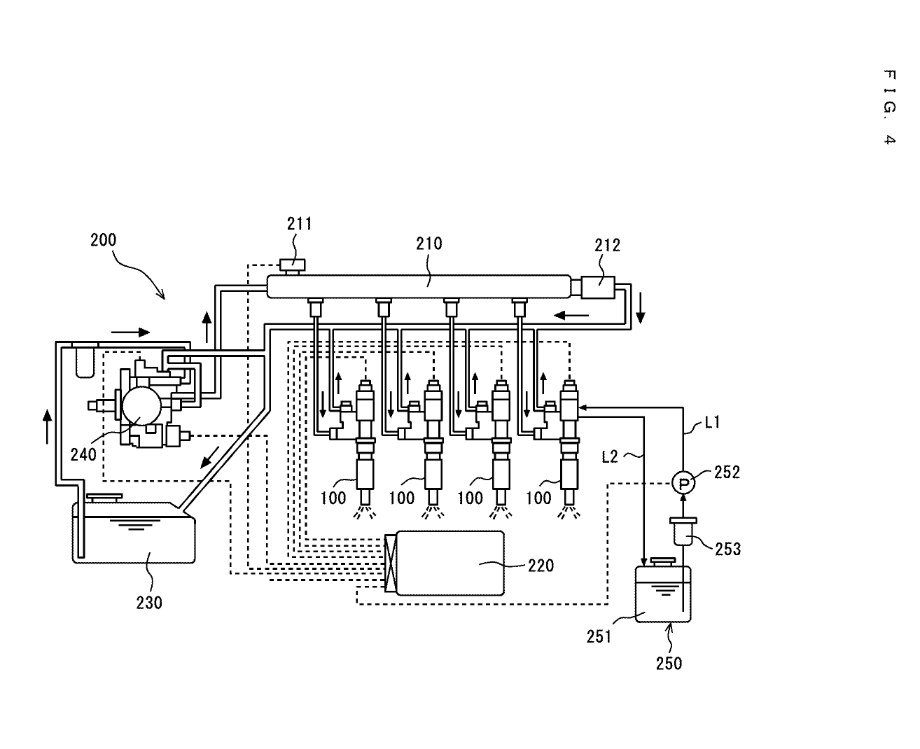

The injector main body 10 has, at its free end (lower end in the drawing), a nozzle 11 for injecting a fuel (light oil). The injector main body has a function of spraying a high-pressure fuel (light oil), which is received from a high-pressure pathway 12, into a cylinder (or cylinders) of a diesel engine (not shown). The high-pressure pathway 12 extends in a longitudinal direction of the injector main body 10 such that the high-pressure pathway lies in parallel to the cylinder chamber 20, and the high-pressure pathway communicates with a common rail 210 shown in FIG. 4 via a high-pressure fuel supply inlet 13 at an upper end of the injector main body 10. A fuel pool or reservoir part 12a and an annular injection passage 12b are provided in the high-pressure pathway 12 near the nozzle 11 so that the fuel supplied into the high-pressure pathway 12 is pressurized in the fuel pool 12a and then injected from the nozzle 11 through the annular injection passage 12b.

At the upper end of the injector main body 10, there are provided a pressure control (pressure suppression) chamber 40 and an electromagnetic valve (solenoid valve) 50. The pressure control chamber 40 communicates with the cylinder chamber 20 through an orifice 21, and has a function of regulating the pressure in the cylinder chamber 20 by receiving a high-pressure fuel from the cylinder chamber 20. Major components of the electromagnetic valve (solenoid valve) 50 are an electromagnet (solenoid coil) 51, a coil spring 52 and a valve body (outer valve) 53, and the electromagnetic valve 50 has a function of opening and closing the pressure control chamber 40 by feeding and no feeding the electricity to the electromagnet (solenoid coil) 51 under the control of the controller 220 shown in FIG. 4. The movements and operations of the electromagnetic valve (solenoid valve) 50 will be described in detail later.

A fuel discharge pathway 15, which serves as a low-pressure pathway, is also connected to the pressure control chamber 40. The fuel discharge pathway has a function of releasing the pressure from the pressure control chamber 40 toward a fuel tank 230, shown in FIG. 4, through a fuel discharge outlet 16 at the upper end of the injector main body 10. Specifically, it has a function of sending the high-pressure fuel, which flows in the pressure control chamber 40 from the orifice 21, back to the fuel tank 230 of FIG. 4 through the fuel discharge outlet 16.

The cylinder chamber 20 extends along the center axis of the injector main body 10, and communicates with the pressure control chamber 40 through the orifice 21 at its upper end. The cylinder chamber also communicates with the high-pressure pathway 12 through a branch line 14 that branches from the high-pressure pathway 12. The lower end of the cylinder chamber 20 communicates with the high-pressure pathway 12 through a guide hole 22. A command piston 30, which has a rod shape, is received in the cylinder chamber 20 such that the command piston can reciprocate (move up and down) in the cylinder chamber. The command piston 30 has a function of pushing a nozzle needle 60, which is received in the guide hole 22 and can reciprocate (move up and down), in a downward direction.

The command piston 30 has a piston main body 31 and a shaft portion 32 extending from the piston main body 31. The command piston 30 also has a spring seat 33 at the free end (lower end) of the shaft portion 32. A coil spring 34 is located between the spring seat 33 and a step portion 23 in the cylinder chamber 20, and the coil spring 34 biases (urges) the entire command piston 30 downward or toward the nozzle 11. The piston main body 31 has a larger diameter portion 30a, which contacts the wall surface of the cylinder chamber 20, and a smaller diameter portion 30b, which is spaced from the wall surface of the cylinder chamber 20 at a predetermined gap 34.

The nozzle needle 60 has a larger diameter portion 61, which slides in the guide hole 22, a smaller diameter portion 62, whose free end contacts and leaves the nozzle 11, and a tapered portion 63, which connects the larger diameter portion to the smaller diameter portion. When the larger diameter portion 61 is pushed downward toward the nozzle 11 by the command piston 30, the free end of the smaller diameter portion 62 abuts the interior of the nozzle 11 and closes the nozzle 11. On the other hand, when the pressure in the upper end area of the cylinder chamber 20 decreases and the pressure in the fuel pool 12a of the high-pressure pathway 12 increases at the same time, then the pressure pushes the tapered portion 63 upward and the free end of the smaller diameter portion 62 leaves the interior of the nozzle 11 to open the nozzle 11.

A cleaning liquid supply pathway 70 for supplying a cleaning liquid to the cylinder chamber 20 and a cleaning liquid discharge pathway 80 for discharging the cleaning liquid from the cylinder chamber 20 are connected to the cylinder chamber 20 of the injector main body 10.

The cleaning liquid supply pathway 70 is connected to the vicinity of the upper end of the cylinder chamber 20, and causes the cleaning liquid to flow into the cylinder chamber 20 from the cleaning liquid feed inlet 71. It should be noted that the cleaning liquid is not limited to a particular kind of liquid as long as the liquid can clean the fuel that flows in the cylinder chamber 20. However, it is preferred that the liquid has a suitable lubricity and does not adversely affect the property of the fuel even if part of the liquid mixes with the fuel. In other words, preferably the cleaning liquid is the fuel (light oil) that is the same as the high-pressure fuel injected from the nozzle 11.

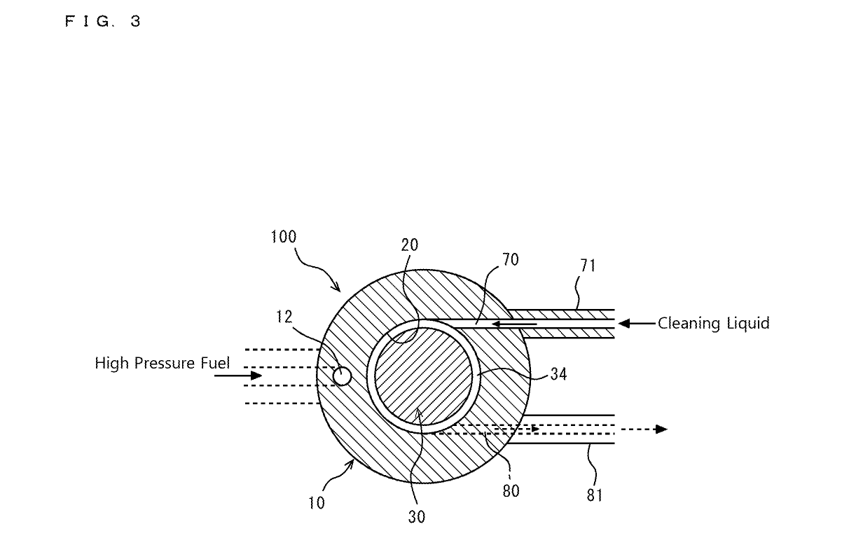

The cleaning liquid discharge pathway 80 is connected to the vicinity of the lower end of the cylinder chamber 20, and causes the cleaning liquid in the cylinder chamber 20 to exit together with the fuel and other matters in the cylinder chamber 20 from the cleaning liquid discharge outlet 81. The cleaning liquid supply pathway 70 and cleaning liquid discharge pathway 80 are connected to the cylinder chamber 20, which has a circular cross-sectional shape as shown in FIG. 3, in a tangential direction. Therefore, the cleaning liquid introduced to the cylinder chamber 20 from the cleaning liquid supply pathway 70 flows downward spirally in the gap 34 along the cylinder chamber wall.

FIG. 4 illustrates one embodiment of a fuel injection system 200 that includes a plurality of injectors 100 (four injectors in the illustrated example). This fuel injection system 200 also includes, as its major components, the fuel tank 230, a high-pressure fuel pump 240, a common rail 210, a controller 220 and an injector cleaning unit or means 250, in addition to the injectors 100, 100, 100 and 100.

The controller 220 monitors the fuel pressure in the common rail 210 with a fuel pressure sensor 211, and controls the high-pressure fuel pump 240 such that the fuel pressure in the common rail 210 becomes an intended pressure (e.g., 150-200 MPa). If the fuel pressure in the common rail 210 rises to an unusual value, then the pressure control valve 212 opens and causes the fuel in the common rail 210 to return to the fuel tank 230. The controller 220 controls the electromagnetic valves 50 of the respective injectors 100, 100, 100 and 100 to control the fuel injection timing and other operations.

The injector cleaning unit 250 includes, as its major components, a cleaning liquid tank 251 for storing the cleaning liquid, a cleaning liquid supply line L1 for connecting the cleaning liquid tank 251 to the cleaning liquid supply pathways 70 of the respective injectors 100, 100, 100 and 100, a cleaning liquid discharge line L2 for connecting the cleaning liquid tank 251 to the cleaning liquid discharge pathways 80 of the respective injectors 100, 100, 100 and 100, and a cleaning liquid pump 252 controlled by the controller 220. The controller 220 activates the cleaning liquid pump 252 at appropriate timing (will be described later) to supply the cleaning liquid from the cleaning liquid tank 251 to the respective injectors 100, 100, 100 and 100. It should be noted that a cleaning liquid filter 253 for filtering the cleaning liquid may be provided at an upstream of the cleaning liquid pump 252.

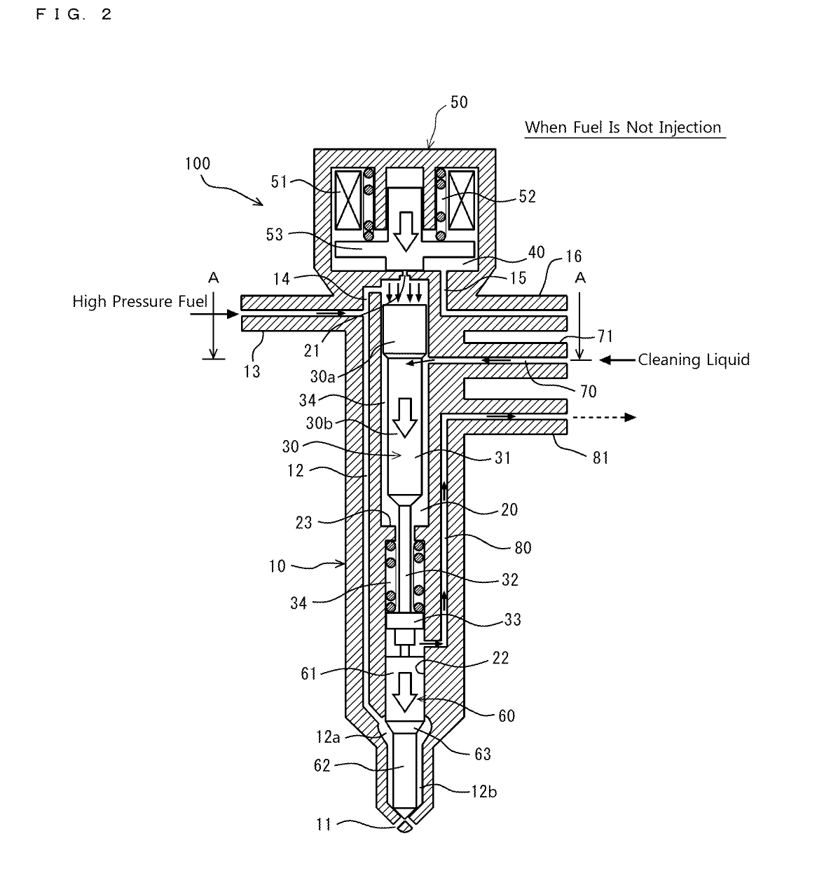

Fundamental movements and operations of the injector 100 and the fuel injection system 200 of the present invention that have the above-described structures will be now described. FIG. 1 shows the injector 100 of the present invention during fuel injection, and FIG. 2 shows the injector 100 during fuel injection (deactivated state). As the electromagnetic valve is turned on as shown in FIG. 1, the electromagnet (solenoid coil) 51 is energized and the valve body 53 is attracted by the electromagnet (solenoid coil) 51 and ascends in spite of the spring force of the coil spring 52 as indicated by the arrow in the drawing.

Then, a slit 21 that connects the upper end portion of the cylinder chamber 20 to the pressure control chamber 40 opens, and the high-pressure fuel flows in the pressure control chamber 40 from the cylinder chamber 20 through the slit 21. As a result, the pressure in the upper end area of the cylinder chamber 20 drops, and simultaneously the pressure in the fuel pool 12a of the high-pressure passage 12 acts on the tapered portion 63 of the nozzle needle 60. This pushes the entire nozzle needle 60 upward as indicated by the arrow in the drawing, and its free end leaves the nozzle 11 to open the nozzle 11. This in turn causes the high-pressure fuel to flow through the injection passage 12b and be injected instantly (immediately) into the diesel engine cylinder(s) (not shown) from the nozzle 11. Part of the fuel in the fuel pool 12a flows in the clearance between the larger diameter portion 61 of the nozzle needle 60 and the nozzle hole 22, and serves as a lubrication agent when the nozzle needle 60 slides. It should be noted that the nozzle needle 60 normally contacts the free end of the spring seat 33 of the command piston 30 and therefore the entire command piston 30 is pushed upward, as indicated by the arrow in the drawing, in spite of the spring force of the coil spring 34 as the entire nozzle needle is pushed upward. This movement is smooth because the pressure in the upper end area of the cylinder chamber 20 drops as described earlier.

If the electromagnetic valve 50 is turned off by the controller 220 from the above-described state, then the valve body 53 leaves the electromagnet 51 as shown in FIG. 2, and at the same time the valve body 53 is pushed toward the cylinder chamber 20 by the spring force of the coil spring 52 to shut the slit 21 and close the pressure control chamber 40. Then, the high-pressure fuel in the cylinder chamber 20 has no place to escape and the pressure in the upper end area of the cylinder chamber steeply increases. As a result, the command piston 30 and the nozzle needle 60 are pushed downward by the fuel pressure and the spring force of the coil spring 34 as indicated by the arrow in the drawing. Therefore, the nozzle is closed and the fuel injection into the diesel engine cylinder(s) (not shown) from the nozzle 11 suddenly stops. The high-pressure fuel that flows in the cylinder chamber 20 moves the command piston 30 downward, and part of the fuel flows in a clearance between the larger diameter portion 30a of the piston main body 31 and the wall of the cylinder chamber 20 and serves as a lubrication agent when the piston main body 31 and other components slide. The above-described movements of the nozzle needle 60 and the command piston 30 by the on/off controlled electromagnetic valve 50 are repeated at the predetermined timing so that combustion takes place in an efficient manner.

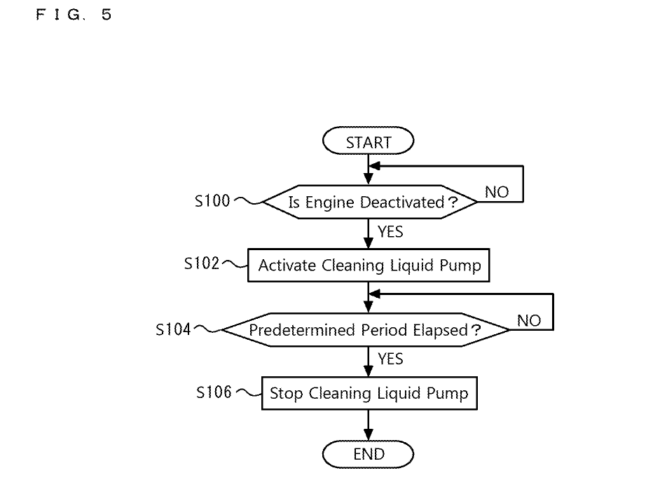

After the engine stops and the fuel injection control is finished, the controller 220 performs the control for cleaning the injector 100 with the injector cleaning unit 250. FIG. 5 shows a flowchart showing one example of the control for cleaning the injector 100 by the controller 220. Firstly, the controller 220 determines at the first step (Step 5100) whether the engine is in a deactivated condition. When the controller 220 determines that the engine is not in the deactivated condition (NO), then the controller 220 waits in a stand-by condition. On the other hand, when the controller 220 determines that the engine is in the deactivated condition (YES), the control proceeds to a next step (Step S102).

In Step 5102, the cleaning liquid pump 252 of the injector cleaning unit 250 is activated for a predetermined period (e.g., several seconds to several ten seconds). This causes the cleaning liquid to flow from the cleaning liquid tank 250 to the injector 100 through the cleaning liquid supply line L1, and the interior of the cylinder chamber 20 of the injector main body 10 is cleaned. Therefore, the probability of generating sticky matters (sludge) in the cylinder chamber 20 decreases. Even if the sticky matters are generated, the sticky matters are discharged out of the cylinder chamber 20 together with the cleaning liquid from the cleaning liquid discharge pathway 80.

As a result, it is possible to reduce or eliminate the generation of the sticky matters (sludge) without using the additive or the like which would adversely affect the fuel composition. As such, it is possible to reliably avoid the inconveniences such as adhesion of the sticky matters onto the wall of the cylinder chamber 20 and the command piston 30, which would result in hindered movements of the command piston. In other words, if the sticky matters (sludge) were generated in the cylinder chamber 20 due to deterioration of the fuel or other reasons, then the sticky matters would slowly precipitate due to the gravity upon deactivation of the engine and subsequent stoppage of the movements of the piston main body 31 as well as stoppage of the flow of the fuel in the cylinder chamber 20. The sticky matters would accumulate and adhere onto the bottom of the cylinder chamber 20, and would hinder the movements of the command piston 30 and other components. By providing the injector cleaning unit 250 that is immediately activated upon the deactivation of the engine, it is possible to expel the sticky matters from the cylinder chamber 20 before the sticky matters precipitate and accumulate on the bottom of the cylinder chamber 20 even if the sticky matters are generated. Because the cleaning is not performed when the engine is running, unexpected situations would not occur. Because the pressure in the cylinder chamber does not become as high as the common rail 210 and the high-pressure passage 12, except for the upper end area of the cylinder chamber 20, high pressure is not required to feed the cleaning liquid. Accordingly, a common inexpensive fuel pump can be used as the cleaning liquid pump 253.

When compared with a drive scheme that is designed to deal with the sticky matters (sludge), the present invention requires less energy to drive the nozzle needle 60 and can realize more stable movements. This contributes to energy saving. The present invention can also avoid the following trouble: unlike the prevent invention, if a large propelling force were applied to the nozzle needle 60, the components would repeat the collision with the large propelling force and their sliding parts would tend to wear, which would in turn cause metal fatigue due to the collision or other reasons and reduce the life of the injector.

Because the cleaning liquid supply pathway 70 and the cleaning liquid discharge pathway 80 are connected to the cylindrical cylinder chamber 20, which has a circular cross-sectional shape, in the tangential direction as shown in FIG. 3, the cleaning liquid flows spirally in the clearance 34 along the wall surface of the cylinder chamber 20 and therefore the cleaning liquid is smoothly supplied and discharged. This results in an improved cleaning effect. It should be noted that only one of the cleaning liquid supply pathway 70 and the cleaning liquid discharge pathway 80 may be connected to the cylinder chamber 20 in the tangential direction. Because the cleaning liquid supply pathway 70 is connected to one end (upper end) of the cylinder chamber 20 and the cleaning liquid discharge pathway 80 is connected to another end (lower end) of the cylinder chamber 20, the cleaning liquid reaches (spreads to) every part of the cylinder chamber 20. This prevents part of the fuel from staying or stagnating in the cylinder chamber 20, and prevents subsequent deterioration of the fuel. Accordingly, an improved cleaning effect is demonstrated.

Although the cleaning liquid tank 25 for dedicated use is prepared and the cleaning liquid stored in the cleaning liquid tank 250 is used in the above-described embodiment as shown in FIG. 4, a fuel that has the same composition as the fuel supplied from the common rail 210 may be used as the cleaning liquid as described earlier. In such case, the fuel or cleaning liquid can be supplied directly from the fuel tank 230 by the cleaning liquid pump 253. In this case, there would be no adverse influence on the movements and operations even if the cleaning liquid introduced to the cylinder chamber 20 mixes with the fuel. In addition, separate preparation of the cleaning liquid and the cleaning liquid tank 250 is not necessary so that the cost can be reduced and the maintenance such as monitoring and filling up of the cleaning liquid becomes unnecessary.

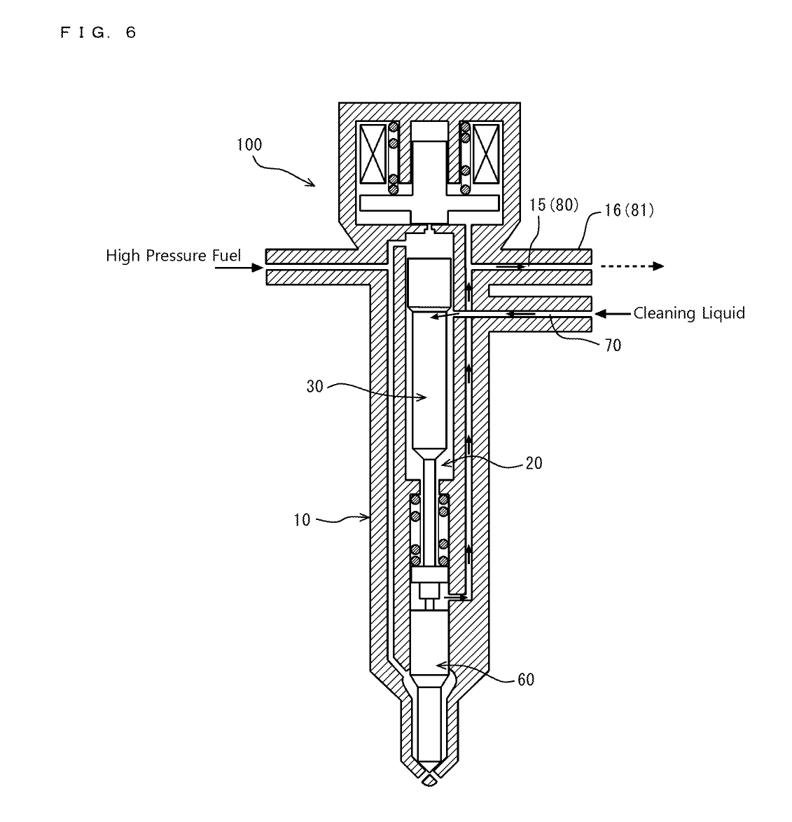

It should also be noted that configurations shown in FIG. 6 to FIG. 8 may be used in other embodiments of the present invention. Specifically, the configuration of FIG. 6 merges the cleaning liquid discharge pathway 80 with the fuel discharge pathway 15 connected to the pressure control chamber 40. This configuration allows the fuel discharge outlet 16 of the fuel discharge pathway 15 to be used as the discharge outlet of the cleaning liquid discharge pathway 80. Therefore, it is not necessary to provide an independent fuel discharge outlet 81 unlike in the above-described embodiment.

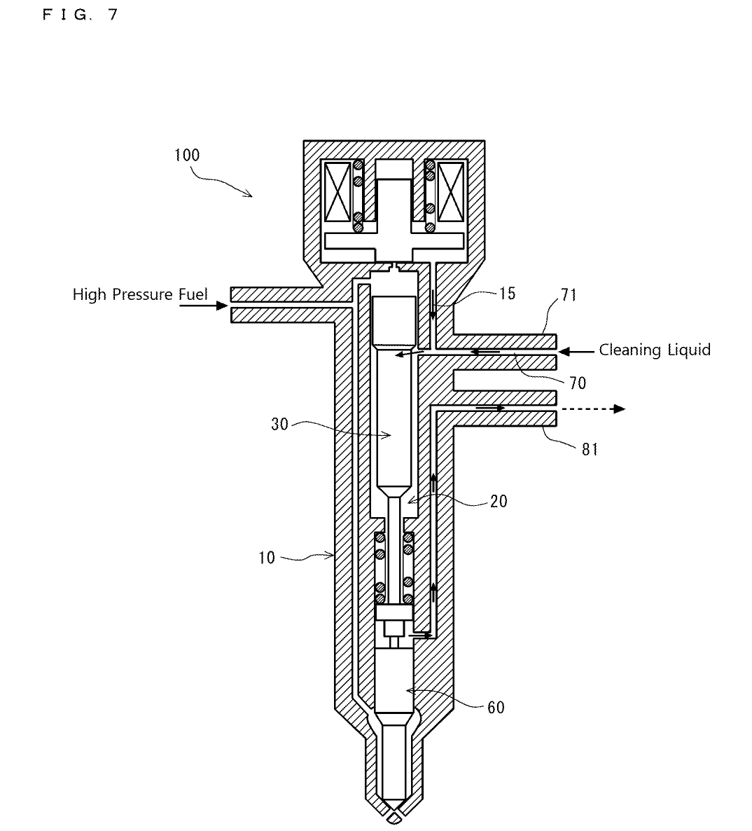

The configuration of FIG. 7 merges the fuel discharge pathway 15, which is connected to the pressure control chamber 40, with the cleaning liquid supply pathway 70 so that part or all of the fuel discharged from the pressure control chamber can be used as the cleaning liquid. This configuration does not need the independent fuel discharge outlet 81 and can use the fuel discharged from the fuel discharge pathway 15 as the cleaning liquid. Accordingly, a cost for independently preparing the cleaning liquid is dispensed with, and the maintenance such as monitoring and filling up of the cleaning liquid becomes unnecessary.

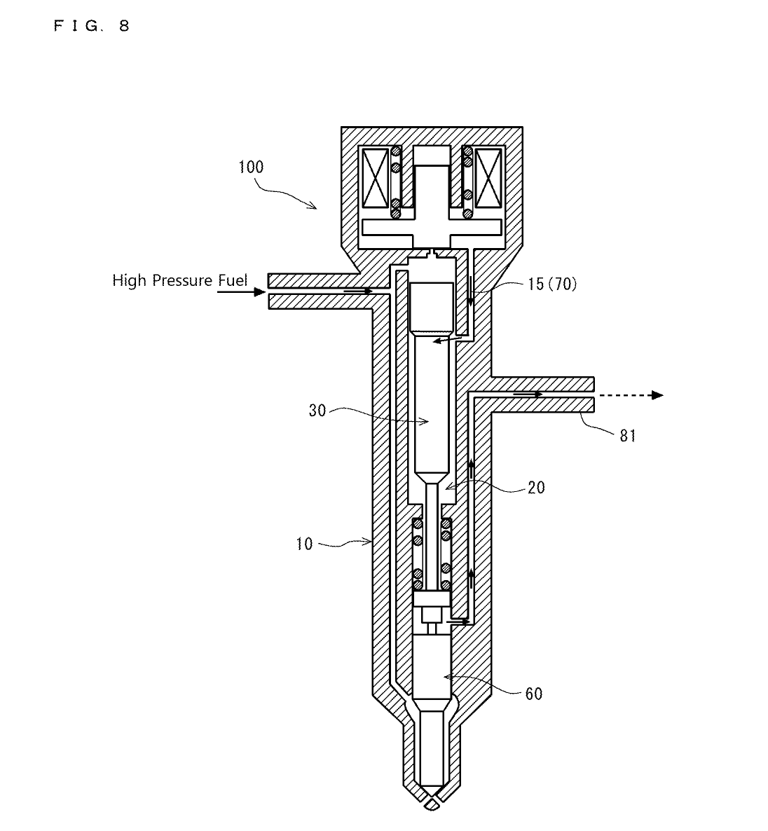

The configuration of FIG. 8 is a further simplification to the configuration of FIG. 7. The fuel discharge pathway 15 extending from the pressure control chamber 40 itself is used as the cleaning liquid supply pathway 70. This configuration can demonstrate similar functions and advantages to the configuration of FIG. 7. Furthermore, the cleaning liquid feed opening 71 is dispensed with, and therefore the structure is further simplified.

If the injector 100 and the fuel injection system 200 of the invention, which have the above-described structure, are used in construction machines such as power shovels, and construction vehicles such as buses and trucks, they contributes to a stable operation of the engine for a long time and makes it possible to provide a highly reliable construction machine and construction vehicle such as buses and trucks.

### REFERENCE NUMERALS AND SYMBOLS

100: Injector
200: Fuel Injection System
210: Common Rail
220: Controller
230: Fuel Tank
240: High Pressure Pump
250: Injector Cleaning Unit
251: Cleaning Liquid Tank
252: Cleaning Liquid Pump
253: Cleaning Liquid Filter
L1: Cleaning Liquid Supply Line
L2: Cleaning Liquid Discharge Line
10: Injector Main Body
11: Nozzle
20: Cylinder Chamber
30: Command Piston
40: Pressure Control Chamber
50: Electromagnetic Valve (Solenoid Valve)
60: Nozzle Needle
70: Cleaning Liquid Supply Pathway
80: Cleaning Liquid Discharge Pathway

1. An injector comprising a cylinder chamber provided in an injector main body, the injector main body having a nozzle for injecting a fuel, and a command piston slidably received in the cylinder chamber for driving a needle, the needle being configured to open and close the nozzle, with a cleaning liquid supply pathway for supplying a cleaning liquid to the cylinder chamber being connected to the cylinder chamber, and a cleaning liquid discharge pathway for discharging the cleaning liquid from the cylinder chamber being connected to the cylinder chamber.

2. The injector according to claim 1, wherein the cylinder chamber has a cylindrical shape, with its cross sectional shape being circular, and one or both of the cleaning liquid supply pathway and the cleaning liquid discharge pathway are connected to the cylinder chamber in a tangential direction.

3. The injector according to claim 1, wherein the cleaning liquid supply pathway is connected to one end of the cylinder chamber, and the cleaning liquid discharge pathway is connected to another end of the cylinder chamber.

4. The injector according to claim 1, wherein the fuel is used as the cleaning liquid.

5. The injector according to claim 1 further comprising a fuel supply pathway for feeding the fuel to the injector main body and a fuel discharge pathway for discharging the fuel from the injector main body, the cleaning liquid discharge pathway being merged with the fuel discharge pathway.

6. The injector according to claim 1 further comprising a fuel supply pathway for feeding the fuel to the injector main body and a fuel discharge pathway for discharging the fuel from the injector main body, the fuel discharge pathway being merged with the cleaning liquid supply pathway.

7. The injector according to claim 1 further comprising a fuel supply pathway for feeding the fuel to the injector main body and a fuel discharge pathway for discharging the fuel from the injector main body, the fuel discharge pathway being connected to the cylinder chamber such that the fuel discharge pathway is used as the cleaning liquid supply pathway.

8. A fuel injection system configured to supply a fuel to an injector defined in claim 1 for fuel injection, comprising injector cleaning means for supplying the cleaning liquid to the cleaning liquid supply pathway to clean the cylinder chamber when an engine equipped with the injector stops.

9. A construction machine comprising the fuel injection system of claim 8.
